(19) United States
(12) Patent Application Publication
(10) Pub. No.: US 2023/0023407 A1
(43) Pub. Date: Jan. 26, 2023

(54) CAMERA ASSEMBLY AND METHOD FOR ASSEMBLYING

(71) Applicant: Robert Bosch GmbH, Stuttgart (DE)

(72) Inventors: Steven E. Garlock, Quarryville, PA (US); Luke D. Grim, Harrisburg, PA (US)

(21) Appl. No.: 17/384,485

(22) Filed: Jul. 23, 2021

(51) Int. Cl. G03B 17/56; H01R 13/631

(52) U.S. Cl. CPC G03B 17/561; H01R 13/6315; G03B 2217/002; H04N 7/18

(57) ABSTRACT

A surveillance camera assembly includes a camera mount having a camera mount housing, a base, and an arm extending between the housing and the base. The base includes a mounting feature for coupling the camera mount to a surface external to the surveillance camera assembly. A camera has a camera housing coupled to the camera mount housing, a camera lens module, and an image sensor configured to generate a first signal. A camera mount accessory has an accessory housing coupled to the camera mount housing. The camera mount accessory further has an electrical component configured to generate a second signal. A circuit board assembly is positioned within the camera mount housing, the circuit board assembly configured to receive the first signal and the second signal.

### BACKGROUND OF THE INVENTION

A camera assembly used for surveillance can contain a camera and one or more circuit boards that, for example, support an image sensor for capturing an image and/or a microphone for recording audio. Additionally, the circuit boards include various components for controlling data transfer, regulating power supply, and controlling movement (pan, tilt, zoom) of the camera assembly. In some camera assemblies, such as ceiling-mounted camera assemblies or pole-mounted camera assemblies, the desired field of view is generally below the camera assembly such that placement of the circuit boards is generally above the camera and between the camera and the structure to which the camera assembly is mounted.

### SUMMARY OF THE INVENTION

The invention provides, in one aspect, a surveillance camera assembly. The surveillance camera assembly includes a camera mount having a camera mount housing, a base, and an arm extending between the housing and the base. The base includes a mounting feature for coupling the camera mount to a surface external to the surveillance camera assembly. A camera has a camera housing coupled to the camera mount housing, a camera lens module, and an image sensor configured to generate a first signal. A camera mount accessory has an accessory housing coupled to the camera mount housing. The camera mount accessory further has an electrical component configured to generate a second signal. A circuit board assembly is positioned within the camera mount housing, the circuit board assembly configured to receive the first signal and the second signal.

The invention provides, in another aspect, a method of assembling a surveillance camera assembly. A camera is electrically coupled to a circuit board assembly positioned within a housing of a camera mount. A housing of the camera is mechanically coupled to the housing of the camera mount. A camera mount accessory is electrically coupled to the circuit board assembly positioned within the housing of the camera mount. The camera mount accessory is mechanically coupled to the housing of the camera mount.

The invention provides, in yet another aspect, a surveillance camera assembly. The surveillance camera assembly includes a camera mount having a camera mount housing configured to couple to a surface external to the surveillance camera assembly. A camera has a camera housing coupled to the camera mount housing, a camera lens module, and an image sensor configured to generate a first signal. A camera mount accessory has an accessory housing coupled to the camera mount housing. The camera mount accessory further has an electrical component selected from the group consisting of a sensor, a lighting device, a power generation device, and a communication device. The electrical component is configured to generate a second signal. A circuit board assembly is positioned within the camera mount housing, the circuit board assembly configured to receive the first signal and the second signal.

### BRIEF DESCRIPTION OF THE DRAWINGS

FIG. 1 is a perspective view of a surveillance camera assembly having a camera, a camera mount, and a camera mount accessory according to one embodiment.

FIG. 2 is a cutaway view illustrating the surveillance camera assembly with the camera electrically decoupled from a circuit board assembly positioned within the camera mounting housing.

FIG. 3 is a cutaway view illustrating the surveillance camera assembly with the camera mount accessory mechanically and electrically decoupled from the circuit board assembly.

FIG. 4 is a perspective view of a surveillance camera assembly according to another embodiment.

FIG. 5 is a simplified side view of the surveillance camera assembly of FIG. 4 illustrating mechanical and electrical connections.

FIG. 6 is a simplified side view of the surveillance camera assembly of FIG. 4 in a disassembled state.

FIG. 7 is a simplified side view of the surveillance camera assembly of FIG. 4 in an assembled state.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

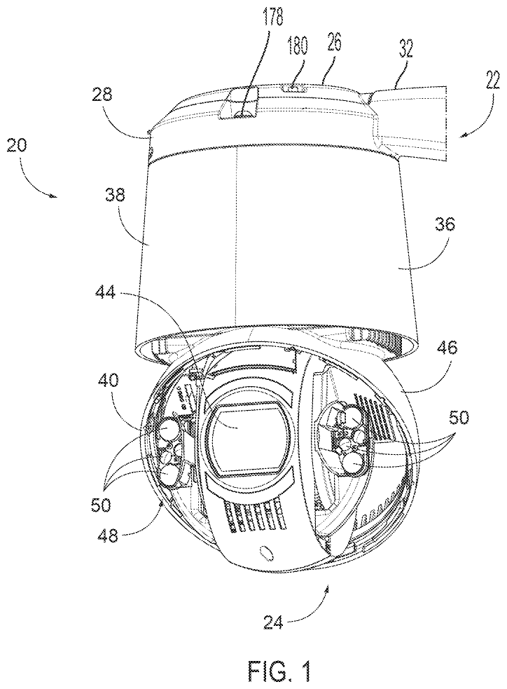

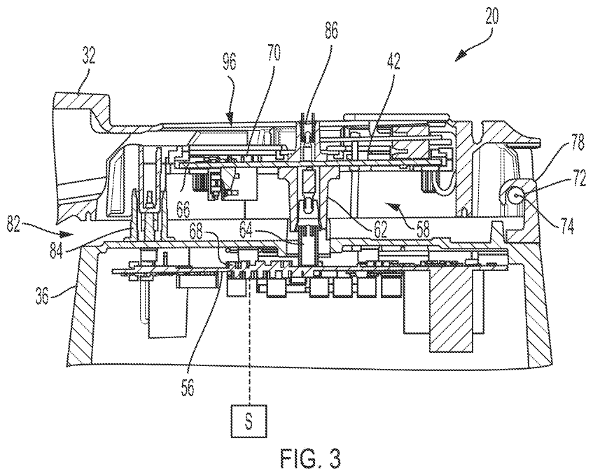

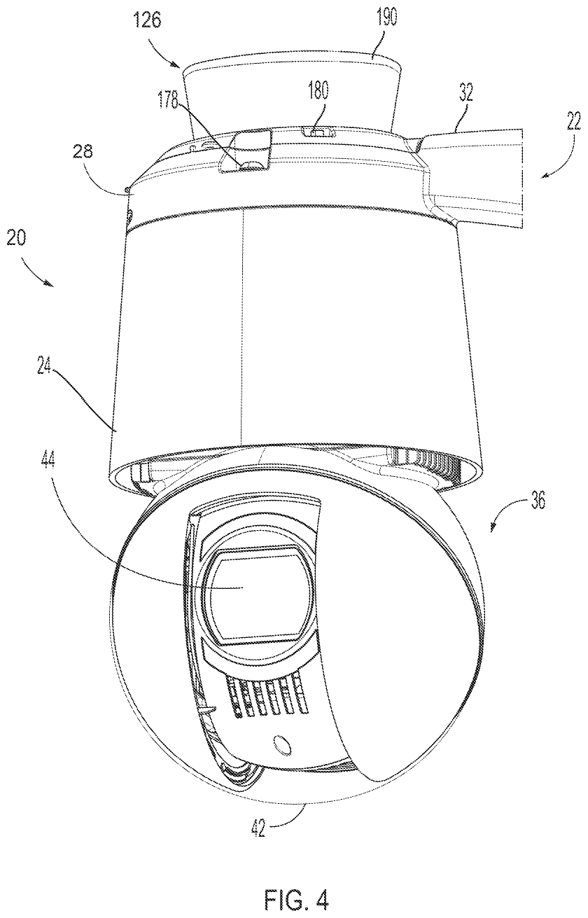

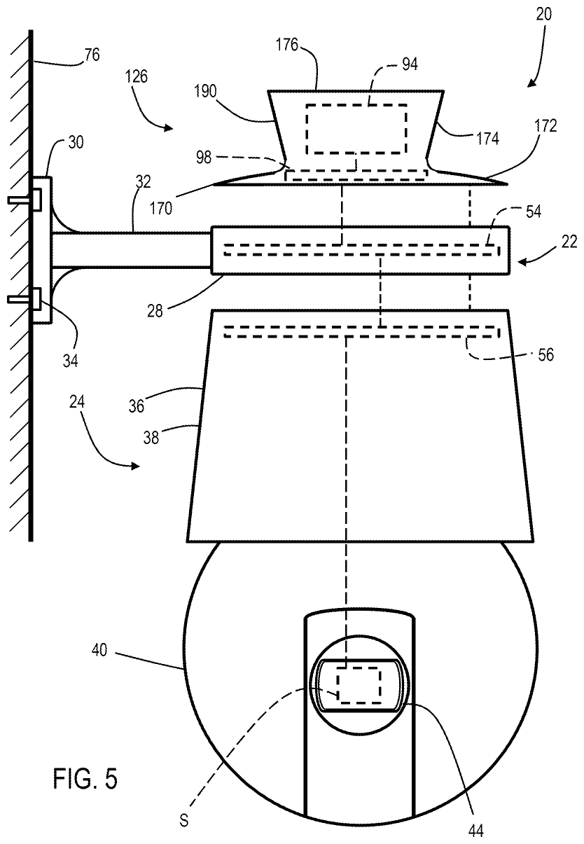

A surveillance camera assembly 20, as shown in FIG. 1, includes a camera mount 22, a camera 24, and a camera mount accessory 26. As shown in FIGS. 5-7, the camera mount 22 includes a camera mount housing 28, a base 30 mountable to a surface 76 external to the surveillance camera assembly 20, and an arm 32 extending between the camera mount housing 28 and the base 30. The base 30 includes a mounting feature such as a bolting flange having a plurality of threaded fasteners 34 adapted for securement to a pole or other fixed structure, e.g., building wall, exterior roof, or interior ceiling. The camera 24 includes a camera housing 36 including a main body shroud 38 and a ball-shaped head portion 40 that depends from the shroud 38. The head portion 40, which is at least partially defined by a translucent dome 42 (FIG. 4), also referred to as a window or a bubble, houses a camera lens module 44 operable to pass imagery of the surrounding area to an image sensor S (FIG. 3) for the creation and collection of still and/or motion surveillance footage. The head portion 40, as shown in FIG. 1, can also include an opaque housing or backing portion 46 joined with the dome 42. In addition to the camera lens module 44, the head portion 40 houses an illuminator module 48 including two separate arrays of lighting elements 50, each array consisting of one or more lighting elements 50 (e.g., LED light sources).

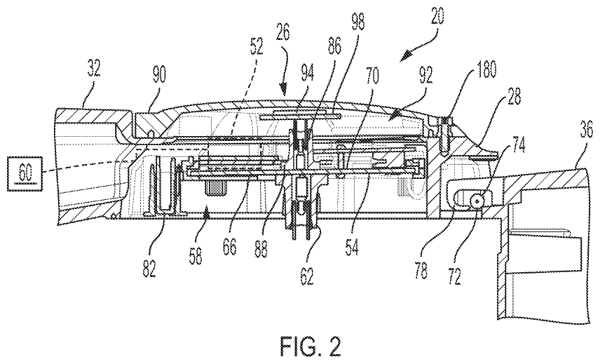

The camera mount housing 28 is coupled to the camera housing 36 and supports the camera housing 36. As shown in FIG. 2, the camera housing 36 is separable from the camera mount housing 28 to provide access to a circuit board assembly 54 located within the camera mount housing 28 and to a circuit board assembly 56 located within the camera housing 36. Providing access to the circuit board assemblies 54, 56 provides for initial assembly of the camera 20 and for repair and component replacement. As shown, the circuit boards 54, 56 are printed circuit boards.

As shown in FIGS. 2-3, the circuit board assembly 54 is located within a recess 58 of the camera mount housing 28 and can include various features for working together with the output of the image sensor S. For example, the circuit board assembly 54 may include elements responsible for power regulation, data storage, and/or data transfer. For wired applications, wires (not shown) may run through the arm 32 of the camera mount 22 to a power source located outside of the surveillance camera assembly 20. The circuit board assemblies 54, 56 may each include a single circuit board or may otherwise include a plurality of circuit boards that are electrically coupled to one another. Additionally, a data transfer module (e.g., Bluetooth, Wi-Fi or other wireless connection, wired connection) is electrically coupled to the circuit board assembly 54 and transmits data from the image sensor S to a storage device 60 (e.g., server, hard drive) and/or to a display for displaying the image captured by the camera 20.

As shown in FIG. 3, the circuit board assembly 56 is electrically coupled to the image sensor S. In some embodiments, the image sensor S is physically mounted on the circuit board assembly 56, though in other embodiments, the image sensor S may be otherwise electrically coupled to the circuit board assembly 56 yet physically decoupled therefrom. The circuit board assembly 56 may be a component of a camera controller 52 that is additionally programmed to facilitate movement of the camera lens module 44 within the dome 42 (e.g., pan, tilt, zoom), control temperature and humidity within the dome 42 (e.g., powering a fan), and control the lighting elements 50, among other functions.

In some embodiments, the circuit board assembly 54 includes elements (e.g., data transfer, power) that are commonly used with various different cameras or not specific to the camera 24. The circuit board assembly 56 includes elements (e.g., image sensor, temperature sensor, etc.) specific to the particular camera 24 such that the camera housing 36 (including the circuit board assembly 56 and the camera lens module 44 located therein) can be replaced with a different camera having a different camera housing.

As shown in FIG. 3, the circuit board assembly 54 within the camera mount housing 28 and the circuit board assembly 56 within the camera housing 36 electrically couple to one another via blind mate connectors 62, 64. The first blind mate connector 62 is coupled to an underside 66 of the circuit board assembly 54 and extends downward from the circuit board assembly 54 toward the circuit board assembly 56. The circuit board assembly 54 additionally includes a top side 70 opposite the underside 66. The second blind mate connector 64 is coupled to a top side 68 of the circuit board assembly 56 and extends upward from the circuit board assembly 56 toward the circuit board assembly 54. When the camera housing 36 is mounted to the camera mount housing 28, the blind mate connectors 62, 64 physically connect to one another to create the electrical connection therebetween. As such, the placement of the second blind mate connector 64 within the camera housing 36 is such that it is aligned with the first blind mate connector 62 in the camera mount housing 28. The blind mate connectors 62, 64 are quick connectors that electrically couple via insertion of one connector 64 (a male connector) into the other connector 62 (a female connector). While the embodiment shown in FIG. 3 illustrates the first blind mate connector 62 as the female connector and the second blind mate connector 64 as the male connector, the arrangement can be switched.

FIG. 3 illustrates the alignment of the camera housing 36 with the camera mount housing 28 via a hook 78 rotatable about an axis 74 defined by a hinge pin 72 and further via a latching assembly 82. Alternative alignment features may be used to align the camera housing 36 relative to the camera mount housing 28 to align the blind mate connectors 62, 64 with one another.

The surveillance camera 20 additionally includes a camera mount accessory 26 (removed in FIG. 3) having an accessory housing 90 defining an interior chamber 92 in which an electrical component 94 is positioned and secured. The camera mount housing 28 includes an upper aperture 96 (FIG. 3) through which the circuit board assembly 54 is accessible. In some embodiments, the aperture 96 is sized such that the circuit board assembly 54 is insertable through the upper aperture 96 into the camera mount housing 28. The camera accessory housing 90 is a cover that seals and closes the aperture 96.

The interior chamber 92 defined by the accessory housing 90 is a hollow recess within the accessory housing 90 and, when the accessory housing 90 is mounted to the camera mount housing 28, the interior chamber 92 combines with the recess 58 and functions as an extension of the recess 58 to increase the enclosed volume or space within the surveillance camera assembly 20.

The electrical component 94 supported in the accessory housing 90 may be, for example, a sensor, a lighting device, a power generation device, or a communication device. A sensor may be, for example, a microphone array, a LIDAR sensor, a RADAR sensor, an air quality sensor, a temperature sensor, or a humidity sensor. A lighting device may be, for example, a light that illuminates an area adjacent to the surveillance camera assembly 20. A power generation device may be, for example, a solar panel. A communication device may be, for example, an antenna or a transmitter for Bluetooth, Wi-Fi, a 5G wireless signal, or the like. The electrical component 94 is separate from the camera 24 and interfaces with the camera 24 via the circuit board assembly 54 as described in greater detail with respect to FIGS. 5-7.

The embodiment shown in FIGS. 1-3, and with particular reference to FIG. 2, shows an accessory housing 90 having a relatively low profile. The height of the accessory housing 90 is less than a height of the camera mount housing 28 to which the accessory housing is fastened. The interior chamber 92 formed therein is likewise similarly shallow having enough height to support a horizontal circuit board assembly 98, the electrical component 94 mounted thereto, and a third blind mate connector 86. The blind mate connector 86 is mounted to an underside of the circuit board assembly 98 such that the circuit board assembly 98 is located between the blind mate connector 86 and the accessory housing 90. A mating, fourth blind mate connector 88 is coupled to the top side 70 of the circuit board assembly 54 for engaging the blind mate connector 86, similar to the engagement between the first and second blind mate connectors 62, 64. With the surveillance camera assembled, the first and second blind mate connectors 62, 64 are located below the lower side 66 of the circuit board assembly 54 and the third and fourth blind mate connectors 86, 88 are located above the top surface 70 of the circuit board assembly 54. As such the circuit board assembly 54 is located between the pairs of blind mate connectors 62, 64 and 86, 88. Likewise, the camera mount housing 28 is sandwiched between the accessory housing 90 mounted to the topside of the camera mount housing 28 and the camera housing 36 mounted to the underside of the camera mount housing 28.

The embodiment shown in FIGS. 4-7 differs from the embodiment shown in FIGS. 1-3 in that the camera mount accessory 126 is modified relative to the camera mount accessory 26. In contrast to locating the electrical component 94 within a shallow recess defined by the cover 90, the accessory housing 190 includes additional structure extending axially upward and away from the camera mount housing 28 beyond the height of the otherwise substantially flat cover. More particularly, the accessory housing includes a first portion 170 adjacent the camera mount housing 28 that includes a flange 172 extending radially outward from a second portion 174 that is formed as a truncated cone, expanding radially outward from the first portion 170 towards a distal end 176 opposite the first portion 170. Function and application of the camera mount accessories 26, 126 and housings 90, 190 are similar to one another except as otherwise described.

The larger accessory housing 190 is capable of housing larger and/or more electrical components 94 than the accessory housing 90 shown in FIG. 2. The accessory housing 190 may be partially or wholly transparent or translucent to allow light (e.g., if the electrical component 94 is a lighting device or solar power generation device) or other waves (e.g., if the electrical component 94 is a communication device) to pass therethrough.

With continued reference to FIGS. 5-7, and in particular with reference to FIG. 5, the camera mount 22, camera 24, and camera mount accessory 126 are electrically and mechanically coupled to one another, as shown. The circuit board assembly 56 of the camera 24 is electrically coupled to the circuit board assembly 54 positioned within the housing 28 of the camera mount 22. Additionally, the image sensor S is electrically coupled with the circuit board assembly 54 indirectly via the circuit board assembly 56. The housing 36 of the camera 24 is mechanically coupled to the housing 28 of the camera mount 22. The camera mount accessory 126 is electrically coupled to the circuit board assembly 54 positioned within the housing 28 of the camera mount 22. The camera mount accessory 126 is mechanically coupled to the housing 28 of the camera mount 22.

As shown in FIGS. 4, the camera 24 and the camera mount accessories 126 are each mechanically coupled to the camera mount housing 28 via a plurality of fasteners 178, 180 such as elastic clips or, as shown, threaded fasteners that tighten down as they are axially inserted into threaded apertures provided on the camera mount housing 28 and the camera housing 36. This mechanical coupling secures the housings 28, 36, 190 to one another.

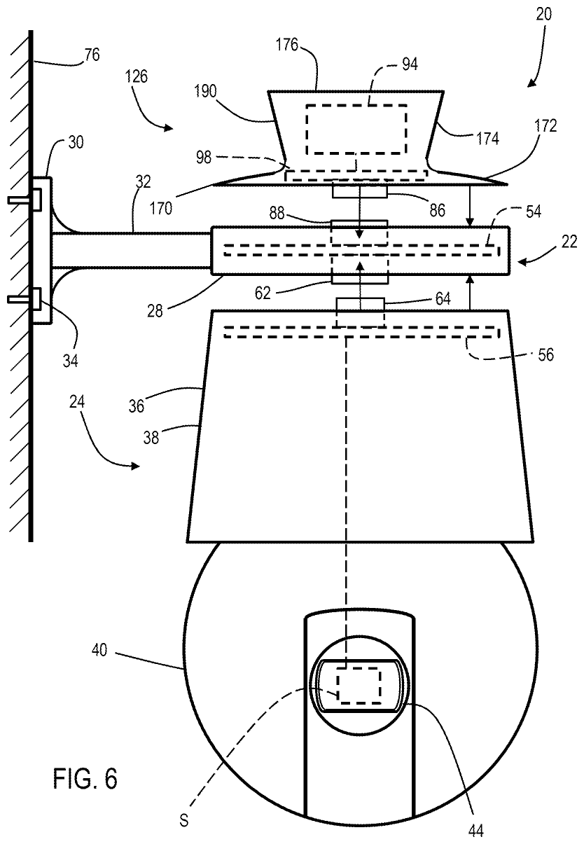

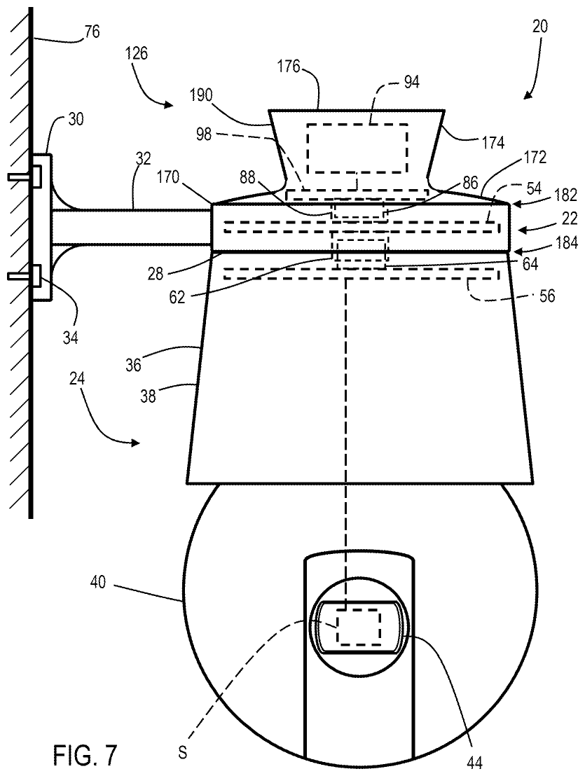

In assembly, as shown in FIGS. 6-7, the image sensor S is electrically coupled to the circuit board assembly 56 within the camera housing 36. The camera housing 36 is aligned with the camera mount housing 28 such that the blind mate connectors 62, 64 are axially aligned with one another. The blind mate connectors 62, 64 are axially connected to one another as shown in FIG. 7, thereby electrically coupling the circuit board assembly 56 to the circuit board assembly 54 within the camera mount housing 28. The camera housing 36 is then mechanically coupled to the underside of the camera mount housing 28 via a plurality of threaded fasteners 178 such that the camera 24 is mechanically and electrically coupled to the camera mount 22.

With continued reference to FIGS. 6-7, the electrical component 94 is electrically coupled to the circuit board assembly 98 within the accessory housing 190. The accessory housing 190 is aligned with the camera mount housing 28 such that the blind mate connectors 86, 88 are axially aligned with one another. The blind mate connectors 86, 88 are axially connected to one another as shown in FIG. 7, thereby electrically coupling the circuit board assembly 98 to the circuit board assembly 54 within the camera mount housing 28. The accessory housing 190 is then mechanically coupled to the topside of the camera mount housing 28 via a plurality of threaded fasteners 180 such that the camera mount accessory 126 is mechanically and electrically coupled to the camera mount 22.

In operation, light through the camera lens module 44 is directed to the image sensor S, which generates a first signal that is transmitted to the circuit board assembly 56. The first signal is transmitted through the electrical connection of the blind mate connectors 62, 64 to the circuit board assembly 54 in the camera mount housing 28. The electrical component 94 generates a second signal that is transmitted to the circuit board assembly 98, through the electrical connection of the blind mate connectors 86, 88 and to the circuit board assembly 54. The first and second signals may be manipulated by various components electrically coupled to the circuit boards 56, 98, which may be considered additional versions of the first and second signals.

The circuit board assembly 54 is configured to interpret the first and second signals and generate a third signal in view of both. For example, if the electrical component 94 is a lighting device, the circuit board assembly 54 may generate a third signal to modify the intensity of the lighting element in view of the first and second signals. Alternatively, if the electrical component 94 is a temperature sensor, the circuit board assembly may transmit a third signal to the storage device that includes the image from the first signal and the temperature at the time of that image. Further still, if the electrical component 94 is a LIDAR sensor that monitors the area around the camera assembly 20, the sensor would continuously generate point cloud data that, when moving, represents scene changes. The signal from the LIDAR sensor interfaces with the camera 24 to move the camera 24 to view scene changes automatically. As yet a further example, if the electrical component is a microphone array, a signal from the microphone array identified as a noise of concern (e.g., a gunshot, a car horn, etc.) in combination with a general direction from which the noise came, is an input to move the camera 24 toward the direction identified by the microphone array. Therefore, the camera 24 and the camera mount accessory 26 are capable of functioning together based on their shared electrical connection through the camera mount housing 28.

As shown in FIG. 7, in the assembled state, at an interface 182 between the camera mount 22 and the camera mount accessory 126, the widths of camera mount housing 28 and the accessory housing 190 are substantially similar (e.g., the smaller of the housings 28, 190 having a width at least 75% the width of the larger of the housings 28, 190) to one another. As the surveillance camera assembly 20 is substantially cylindrical, the widths are the diameters of the housings 28, 190 at the interface 182. With the widths similar to one another, the transition between the housings 28, 190 can appear relatively seamless such that the housings 28, 190 appear as a single component. The widths of the camera mount housing 28 and the camera housing 36 are likewise substantially similar to one another such that the housings 28, 36, 190 have a single, continuous contour and collectively appear as a single component.

Although the invention has been described in detail with reference to certain preferred embodiments, variations and modifications exist within the scope and spirit of one or more independent aspects of the invention as described.

What is claimed is:

1. A surveillance camera assembly comprising:
a camera mount having a camera mount housing, a base, and an arm extending between the housing and the base, wherein the base includes a mounting feature for coupling the camera mount to a surface external to the surveillance camera assembly;
a camera having a camera housing coupled to the camera mount housing, the camera further including a camera lens module, and an image sensor configured to generate a first signal;
a camera mount accessory having an accessory housing coupled to the camera mount housing, the camera mount accessory further having an electrical component configured to generate a second signal; and
a circuit board assembly positioned within the camera mount housing, the circuit board assembly coupled to the image sensor to receive the first signal and coupled to the electrical component of the camera mount accessory to receive the second signal.

2. The surveillance camera assembly of claim 1, wherein the camera includes a circuit board assembly electrically coupled to the image sensor, the circuit board assembly of the camera having a blind mate connector configured to electrically couple the circuit board assembly of the camera to the circuit board assembly.

3. The surveillance camera assembly of claim 2, wherein the blind mate connector of the circuit board assembly of the camera is a first blind mate connector, and wherein the camera mount accessory includes a circuit board assembly electrically coupled to the electrical component, the circuit board assembly of the camera mount accessory having a second blind mate connector configured to electrically couple the circuit board assembly of the camera mount accessory to the circuit board assembly.

4. The surveillance camera assembly of claim 3, wherein the circuit board assembly includes a first side and a second side opposite the first side, wherein the first blind mate connector electrically connects to the first side of the circuit board assembly and the second blind mate connector electrically connects to the second side of the circuit board assembly such that the circuit board assembly is located between the camera and the camera mount accessory.

5. The surveillance camera assembly of claim 1, wherein the camera mount housing is sandwiched between the camera housing and the accessory housing.

6. The surveillance camera assembly of claim 1, wherein the circuit board assembly includes a controller programmed to generate a third signal in response to the first signal and/or the second signal.

7. The surveillance camera assembly of claim 1, wherein the camera mount accessory housing is mechanically coupled to the camera mount housing via a first plurality of threaded fasteners, and wherein the camera housing is mechanically coupled to the camera mount housing via a second plurality of threaded fasteners.

8. The surveillance camera assembly of claim 1, wherein the second signal is configured to modify an operational parameter of the camera.

9. The surveillance camera assembly of claim 1, wherein the camera mount housing defines an aperture through which the circuit board assembly is insertable into the camera mount housing, and wherein the accessory housing is a cover that sealingly closes the aperture.

10. The surveillance camera assembly of claim 1, further comprising an interface where the camera mount housing engages the accessory housing, wherein a width of the camera mount housing at the interface is similar to a width of the accessory housing at the interface such that the camera mount housing and the accessory housing appear to have a single, continuous contour.

11. A method of assembling a surveillance camera assembly, the method comprising:
electrically coupling a camera to a circuit board assembly positioned within a housing of a camera mount;
mechanically coupling a housing of the camera to the housing of the camera mount;
electrically coupling a camera mount accessory to the circuit board assembly positioned within the housing of the camera mount; and
mechanically coupling the camera mount accessory to the housing of the camera mount.

12. The method of claim 11, wherein mechanically coupling the camera to the housing of the camera mount and mechanically coupling the camera mount accessory to the housing of the camera mount sandwiches the camera mount between the camera mount accessory and the housing of the camera.

13. The method of claim 11, wherein electrically coupling the camera to the circuit board assembly includes translating the camera relative to the circuit board assembly to engage a blind mate connector.

14. The method of claim 11, wherein electrically coupling the camera mount accessory to the circuit board assembly includes translating the camera relative to the circuit board assembly to engage a blind mate connector.

15. The method of claim 11, wherein mechanically coupling the camera mount accessory to the housing of the camera mount includes covering and sealing an aperture of the housing of the camera mount through which the circuit board assembly is accessible.

16. A surveillance camera assembly comprising:
a camera mount having a camera mount housing, the camera mount configured to couple to a surface external to the surveillance camera assembly;
a camera having a camera housing coupled to the camera mount housing, the camera further including a camera lens module, and an image sensor configured to generate a first signal;
a camera mount accessory having an accessory housing coupled to the camera mount housing, the camera mount accessory further having an electrical component selected from the group consisting of: a sensor, a lighting device, a power generation device, and a communication device, the electrical component configured to generate a second signal; and
a circuit board assembly positioned within the camera mount housing, the circuit board assembly coupled to the image sensor to receive the first signal and coupled to the electrical component of the camera mount accessory to receive the second signal.

17. The surveillance camera assembly of claim 16, wherein the camera includes a circuit board assembly electrically coupled to the image sensor, the circuit board assembly of the camera having a blind mate connector configured to electrically couple the circuit board assembly of the camera to the circuit board assembly.

18. The surveillance camera assembly of claim 17, wherein the blind mate connector of the circuit board assembly of the camera is a first blind mate connector, and wherein the camera mount accessory includes a circuit board assembly electrically coupled to the electrical component, the circuit board assembly of the camera mount accessory having a second blind mate connector configured to electrically couple the circuit board assembly of the camera mount accessory to the circuit board assembly.

19. The surveillance camera assembly of claim 18, wherein the circuit board assembly includes a first side and a second side opposite the first side, wherein the first blind mate connector electrically connects to the first side of the circuit board assembly and the second blind mate connector electrically connects to the second side of the circuit board assembly such that the circuit board assembly is located between the camera and the camera mount accessory.

20. The surveillance camera assembly of claim 16, wherein the camera mount housing is sandwiched between camera housing and the accessory housing.
